(19) United States
(12) Patent Application Publication
(10) Pub. No.: US 2005/0225632 A1
(43) Pub. Date: Oct. 13, 2005

(54) Apparatus and method for acquiring a complete image of a surface of a semiconductor substrate

(75) Inventors: Thomas Iffland, Jena (DE); Klaus Hallmeyer, Kahla (DE); Regina Hartleb, Jena (DE)

Correspondence Address: HOUSTON ELISEEVA, 4 MILITIA DRIVE, SUITE 4, LEXINGTON, MA, 02421, US

(73) Assignee: Leica Microsystems Jena GmbH, Jena (DE)

(21) Appl. No.: 11/094,721

(22) Filed: Mar. 30, 2005

(30) Foreign Application Priority Data
Apr. 10, 2004 (DE) DE102004017690.6

(51) Int. Cl. H04N 7/18

(52) U.S. Cl. 348/87

(57) ABSTRACT

An apparatus (2) and a method for acquiring a complete image of a surface (4) of a semiconductor substrate (6) are disclosed. The apparatus encompasses a digital camera (11) having an objective (5) and a CCD chip (12). The objective (5) defines an optical axis (7) that is perpendicular to the CCD chip (12). Also provided is an illumination device (14) that is arranged above the surface (4) of the semiconductor substrate (6). The optical axis (7) forms with the surface (4) of the semiconductor substrate (6) an angle ([alpha]) that is less than 90°.

### RELATED APPLICATIONS

This application claims priority of the German patent application 10 2004 017 690.6 which is incorporated by reference herein.

### FIELD OF THE INVENTION

The invention concerns an apparatus for acquiring a complete image of a surface of a semiconductor substrate. In particular, the apparatus for acquiring a complete image of a surface of a semiconductor substrate encompasses a digital camera having an objective and a CCD chip, the objective defining an optical axis that is perpendicular to the CCD chip. Also provided is an illumination apparatus that is arranged above the surface of the semiconductor substrate.

The invention further concerns a method for acquiring a complete image of a surface of a semiconductor substrate. In particular, the invention concerns a method for acquiring a complete image of a surface of a semiconductor substrate using a digital camera having an objective and a CCD chip, the objective defining an optical axis that is perpendicular to the CCD chip; and using an illuminating device that is arranged above the surface of the semiconductor substrate.

### BACKGROUND OF THE INVENTION

Patent Abstracts of Japan, Publication No. 10 284576 discloses a conveyor arrangement for a wafer. Arranged directly above the wafer is a CCD camera with which a two-dimensional image of the entire wafer can be acquired. The optical axis of the CCD camera is perpendicular to the wafer, which has a disadvantageous effect on image acquisition because reflections from the wafer surface are also imaged onto the CCD chip.

Patent Abstracts of Japan, Publication No. 08 247957 discloses an apparatus for defect detection on wafers. The light sources are arranged in such a way that an oblique illumination of the wafer surface is accomplished. A CCD camera that acquires an image of the wafer is likewise provided. Here again, the optical axis of the CCD camera is arranged perpendicular to the surface of the wafer.

European Patent Application EP 0 977 029 A1 discloses an apparatus for the inspection of patterns on semiconductor substrates. An illumination system and a CCD camera are arranged above the surface of the wafer. The arrangement of the illumination system and of the CCD camera is such that their optical axes are inclined in identical fashion with respect to the line normal to the surface of the wafer. Acquisition of an overview image of the entire surface of a wafer is not provided for here.

### SUMMARY OF THE INVENTION

It is the object of the invention to create an apparatus with which acquisition of a complete image of a surface of a semiconductor substrate is possible without having the acquired image negatively influenced by reflections or inhomogeneous illumination of the surface of the semiconductor substrate.

The object is achieved by way of an apparatus for acquiring a complete image of a surface of a semiconductor substrate, comprising: a digital camera having an objective and a CCD chip, wherein the objective defines an optical axis that is perpendicular to the CCD chip, a diffuser screen, and an illumination device that is arranged above the surface of the semiconductor substrate, wherein the optical axis encloses an angle of less than 90° with the surface of the semiconductor substrate, and wherein the angle between the optical axis and the surface of the semiconductor substrate is always dimensioned in such a way that the reflection of the optical axis from the surface of the semiconductor substrate always strikes a diffuser screen.

A further object of the invention is to create a method with which the complete image of a semiconductor substrate can be acquired without having the image disrupted by reflections or inhomogeneous illumination conditions of the surface of the semiconductor substrate.

This object is achieved by way of a method for acquiring a complete image of a surface of a semiconductor substrate using a digital camera having an objective and a CCD chip, an objective defining an optical axis that is perpendicular to the CCD chip; and using an illumination apparatus that is arranged above the surface of the semiconductor substrate, comprising the steps of:
aligning the optical axis in such a way that an angle of less than 90° is enclosed with the surface of the semiconductor substrate; and
adjusting the illumination device using multiple displaceable panels in such a way that by means of the illumination device, an emission cone is defined so that no direct light from the illumination device is incident onto the surface of the semiconductor substrate.

It is advantageous if the apparatus for acquiring a complete image of a surface of a semiconductor substrate encompasses a digital camera having an objective and a CCD chip; and that the optical axis of the optical system of the digital camera encloses an angle of less than 90° with the surface of the semiconductor substrate. It is particularly advantageous if the angle that the optical axis encloses with the surface of the semiconductor substrate is between 60° and 50°. In particular fashion, it is advantageous if the angle equals 52°. A diffuser screen that partially surrounds the semiconductor substrate is arranged behind the semiconductor substrate, opposite the illumination device. A first rail is provided on which the digital camera and the illumination device are displaceably mounted. Also provided is a second rail on which the diffuser screen is displaceably mounted. The arrangement of the digital camera and of the illumination device on the first rail is such that the digital camera is provided above the illumination device.

In addition, the illumination device is provided with multiple displaceable panels that define an emission cone of the illumination device, which cone is configured in such a way that no direct light from the illumination device is incident onto the surface of the semiconductor substrate. Mounted on the second rail is the diffuser screen, which has the shape of a half-cylinder and surrounds approximately half of the semiconductor substrate. The distance from the diffuser screen to the edge of the semiconductor substrate is likewise embodied modifiably.

The method is advantageously embodied in such a way that firstly the optical axis of the objective of the digital camera is arranged in such a way that that axis encloses an angle of less than 90° with the surface of the semiconductor substrate. Adjustment of the illumination device using multiple displaceable panels is then accomplished in such a way that by means of the illumination device, an emission cone is defined so that no direct light from the illumination device is incident onto the surface of the semiconductor substrate. The image acquired with the digital camera is electronically corrected in such a way that the image of the surface of the semiconductor substrate is presented in distortion-free fashion to the user on a display. On the distortion-free complete image of the surface of the semiconductor substrate on the display, the user can select, with the cursor, a desired position or measurement position at which he or she wishes a closer examination.

### BRIEF DESCRIPTION OF THE DRAWINGS

The subject matter of the invention is depicted schematically in the drawings and will be described below with reference to the Figures, in which:

FIG. 1 schematically depicts the configuration of the apparatus for acquiring a complete image of a surface of a semiconductor substrate;

FIG. 2 is a perspective view of the apparatus for acquiring a complete image of a surface of a semiconductor substrate;

FIG. 3 is a side view of the apparatus for acquiring a complete image of a surface of a semiconductor substrate;

FIG. 4 is a plan view of the apparatus for acquiring a complete image of a surface of a semiconductor substrate;

FIG. 5 is an enlarged view of the illumination device for the apparatus for acquiring a complete image of a surface of a semiconductor substrate;

FIG. 6 is a view of the apparatus for acquiring a complete image of a surface of a semiconductor substrate together with a computer and a display; and

FIG. 7 schematically depicts the image of the surface of a semiconductor substrate in distorted form.

### DETAILED DESCRIPTION OF THE INVENTION

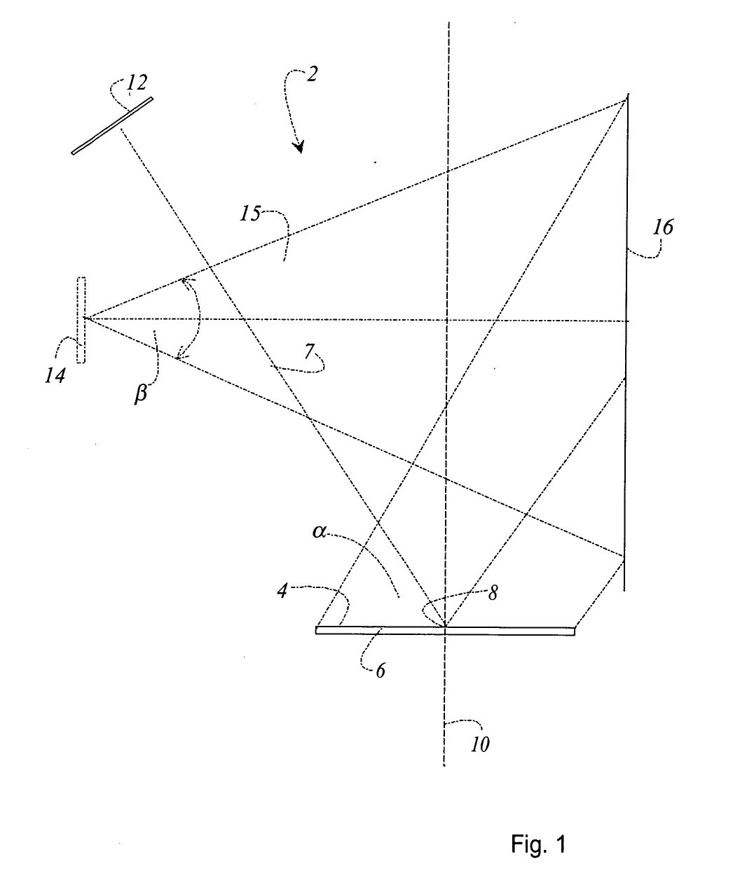

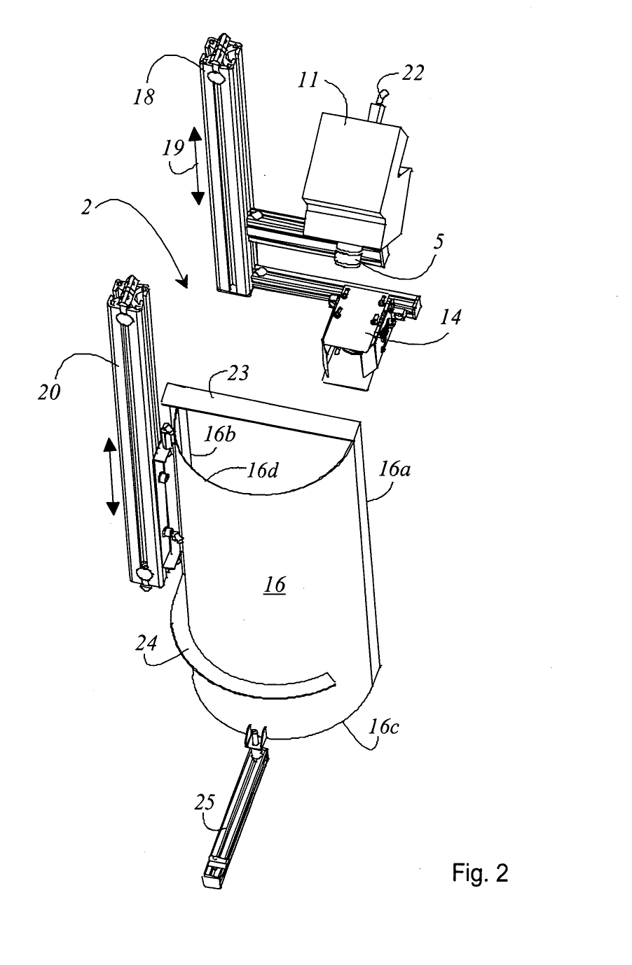

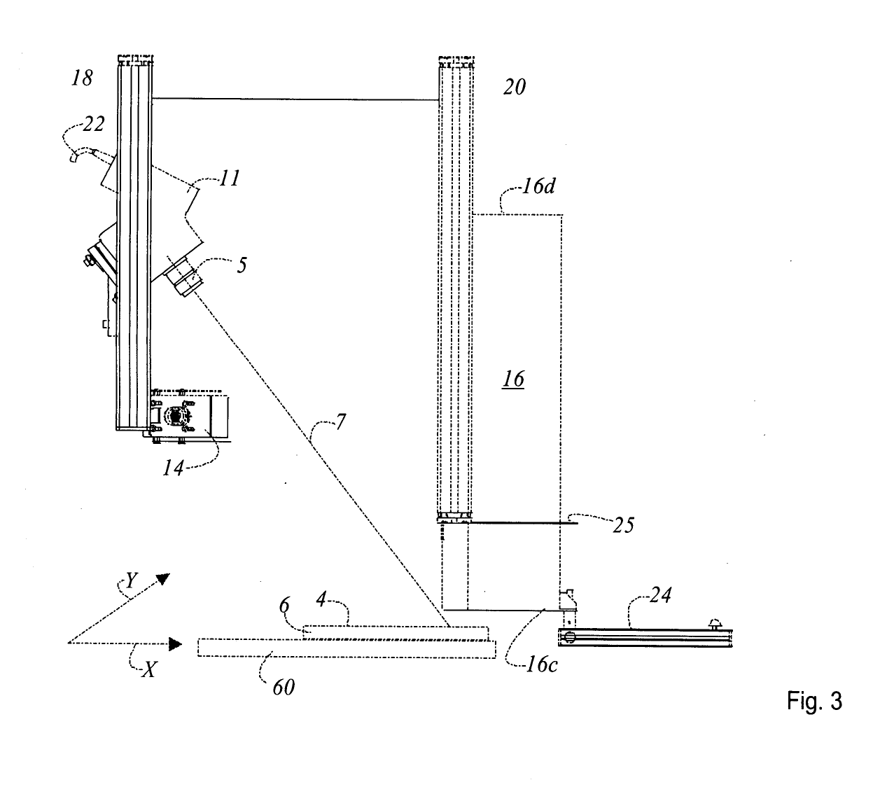

FIG. 1 shows a schematic configuration of an apparatus 2 for acquiring a complete overview image of a surface 4 of a semiconductor substrate 6. Semiconductor substrate 6 is usually a wafer, and is therefore round. The semiconductor substrate can also be a mask or a wafer having a plurality of micromechanical components. If semiconductor substrate 6 is round, it thus defines a center point 8 through which extends a center axis 10 that is perpendicular to surface 4 of semiconductor substrate 6. Arranged to the left of center axis 10 is a CCD chip 12 of a digital camera 11 (see FIG. 2). An illumination device 14 is provided on the same side below CCD chip 12. A diffuser screen 16 is arranged on the right side of center axis 10. Illumination device 14 emits a light cone 15 at an angle β so that this light cone 15 exclusively strikes diffuser screen 16. As is apparent from the Figures that follow, an objective 5 (see FIG. 3) that defines an optical axis 7 is provided in front of CCD chip 12. Optical axis 7 is perpendicular to CCD chip 12 of digital camera 11. Digital camera 11 is arranged in such a way that optical axis 7 extends through center point 8 of semiconductor substrate 6 and encloses an angle α with surface 4 of semiconductor substrate 6. Angle α is less than 90°. In a preferred embodiment, angle α is between 45° and 60°. In a particularly advantageous implementation of the invention, angle α equals 52°. Angle α between optical axis 7 and surface 4 of semiconductor substrate 6 is always dimensioned in such a way that the reflection of optical axis 7 from surface 4 of semiconductor substrate 6 always strikes diffuser screen 16.

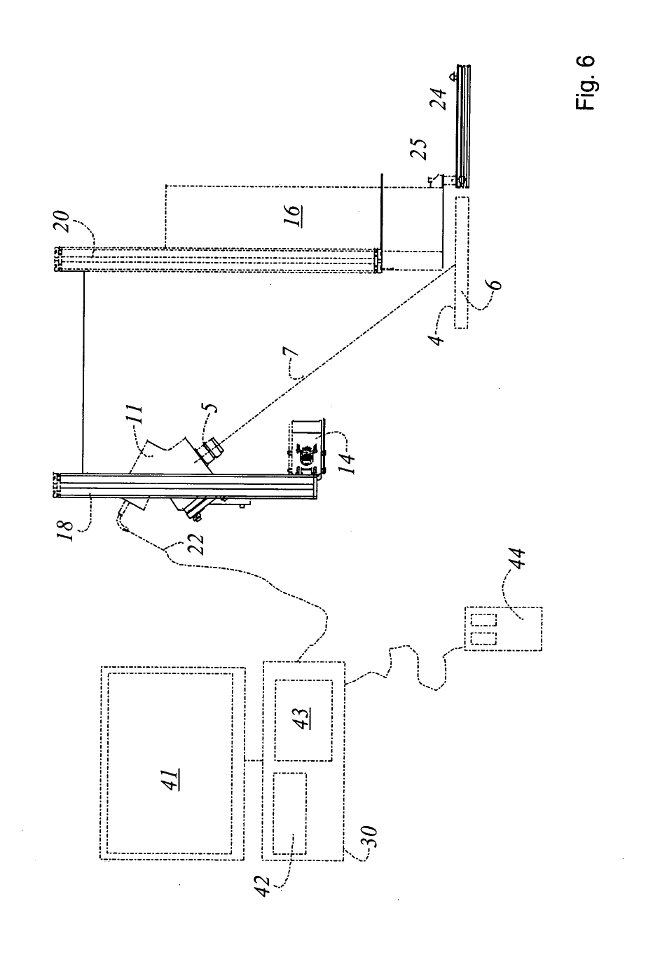

FIG. 2 is a perspective view of apparatus 2 for imaging an entire surface 4 of a semiconductor substrate 6. Digital camera 11 and illumination device 14 are mounted on a first rail 18, digital camera 11 being located above illumination device 14. Digital camera 111 and illumination device 14 can be modified in terms of their position with respect to one another on first rail 18 along a double arrow 19. Digital camera 11 possesses a connector cable 22 through which the acquired image data are transmitted to a computer 30 (see FIG. 6). Diffuser screen 16 is provided opposite the arrangement of digital camera 11 and illumination device 14. Diffuser screen 16 is mounted on a second rail 20, displaceably along a double arrow 21. Diffuser screen 16 is embodied substantially in the shape of a half-cylinder. Diffuser screen 16 defines a first front edge 16a and a second front edge 16b, which are secured in a retaining frame 23. Diffuser screen 16 also defines an upper circle segment 16d and a lower circle segment 16c. A displacement unit 25 is provided on lower circle segment 16c in order to press diffuser screen 16 against a support element 24 so as thereby to achieve better dimensional stability for diffuser screen 16.

FIG. 3 is a side view of apparatus 2 for acquiring a complete image of surface 4 of a semiconductor substrate 6. Digital camera 11 is provided with an objective 5 that defines an optical axis 7. As already mentioned, digital camera 11 is arranged in such a way that the optical axis extends through center point 8 of semiconductor substrate 6. Digital camera 11 is arranged above illumination device 14 on first rail 18. Opposite first rail 18, a second rail 20 is provided on which diffuser screen 16 is displaceably mounted. Diffuser screen 16 is arranged on second rail 20 in such a way that lower circle segment 16c of diffuser screen 16 is located above the level of surface 4 of semiconductor substrate 6.

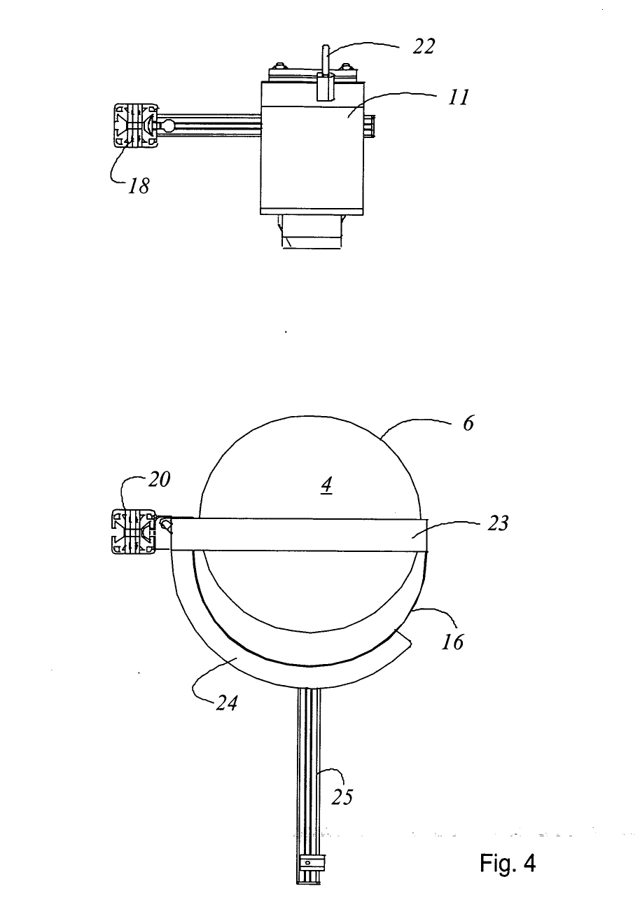

FIG. 4 is a plan view of apparatus 2 for acquiring a complete overview image of a surface 4 of a semiconductor substrate 6. In this depiction, semiconductor substrate 6 is embodied as a disk. Diffuser screen 16, together with retaining frame 23, surrounds approximately half of semiconductor substrate 6. As already described several times, digital camera 11 and illumination device 14 are arranged opposite semiconductor substrate 6 and diffuser screen 16.

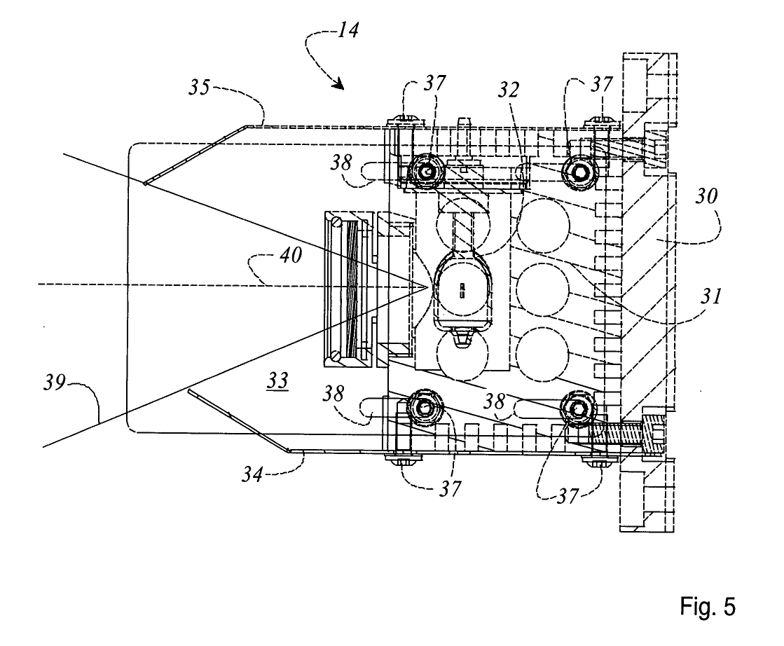

FIG. 5 is a view of illumination device 14. Illumination device 14 is secured to a retaining rail 29 with which it is slidably secured on first rail 18. Illumination device 14 encompasses a lamp body 31 that carries lamp 32. A lower panel 33, a first side panel 34, a second side panel 35, and an upper panel 36 are secured on lamp body 31. Upper panel 36 has been omitted from the depiction shown in FIG. 5 so as thereby to give a better impression of the configuration of illumination device 14. Illumination device 14 defines a center axis 40 that defines the principal emission direction of illumination device 14. Lower panel 33, first side panel 34, second side panel 35, and upper panel 36 are respectively secured to lamp body 31 with screws 37. Lower panel 33, first side panel 34, second side panel 35, and upper panel 36 each have multiple elongated holes 38 through which screws 37 are guided. By loosening screws 37, each of panels 33, 34, 35, and 36 can be displaced parallel to center axis 40. By means of this displacement it is possible to configure and shape light cone 15 proceeding from illumination device 14 in accordance with the conditions of apparatus 2. First and second side panels 34 and 35 each have an angled region 26; angled regions 26 point toward one another.

FIG. 6 shows the arrangement of apparatus 2 described in FIG. 3, in combination with a computer 30. The image data acquired by camera 11 are transferred via a cable 22 to computer 30. The image of surface 4 of semiconductor substrate 6 is visualized for the user on a display 41. By way of an input unit 44, the user can selected a defined site on surface 4 of semiconductor substrate 6 in order to carry out a closer examination or measurement there. The image of surface 4 of semiconductor substrate 6 presented on display 41 is distortion-free. Digital camera 11 acquires the complete image of surface 4 of semiconductor substrate 6 with distortion. This distortion must be corrected prior to presentation on display 41. A corresponding processor 42 is provided for that purpose in computer 30. The user can store the distortion-free image of surface 4 of semiconductor substrate 6 in a memory 43 of computer 30. Although the description refers to only one computer 30, it is self-evident to one skilled in the art that processor 42 and memory 43 can also be part of an overall network in a factory for semiconductor production.

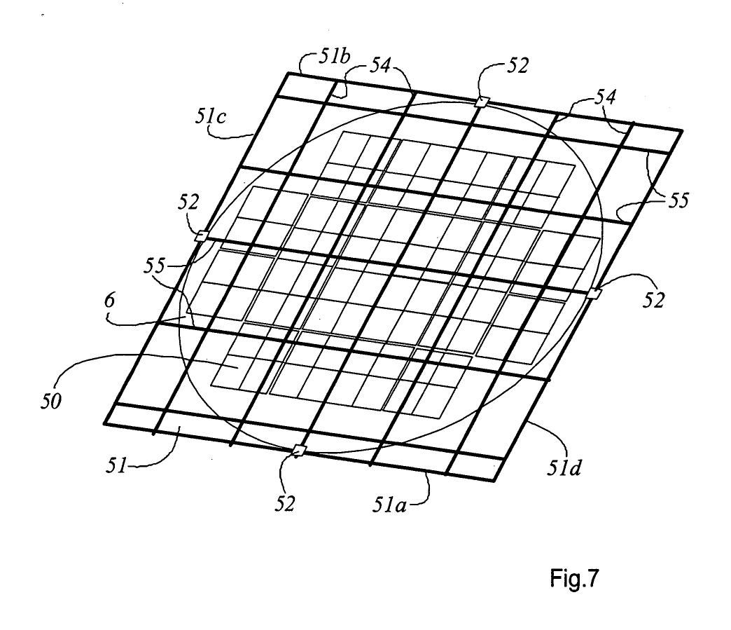

FIG. 7 shows the distorted image of the surface of a semiconductor substrate 6. Semiconductor substrate 6 is in this case a wafer on which multiple dice 50 are patterned. The distorted image of surface 4 of semiconductor substrate 6 is presented to the user on display 41 of computer 30. For the transformation of semiconductor substrate 6 that has been imaged in distorted fashion, it is necessary to determine a rectangle 51 that encloses the distorted image of semiconductor substrate 6. After transformation of the distorted image of the semiconductor substrate into a circle that would correspond to an image acquired by a camera that is arranged in, or at least is parallel to, the center axis of semiconductor substrate 6. Rectangle 51 is defined by a lower side 51a, an upper side 51b, a left side 51c, and a right side 51d. Rectangle 51 is subdivided into multiple grid lines, of which a first group 54 is aligned parallel to left side 51c and to right side 51d. Also provided is a second group 55 of grid lines that are arranged parallel to lower side 51a and to upper side 51b. The distorted image of surface 4 of the semiconductor substrate is displayed to the user on display 41 of computer 30. The user then adapts rectangle 51 to semiconductor substrate 6 in such a way that lower side 51a, upper side 51b, left side 51c, and right side 51d touch the semiconductor substrate. For that purpose, rectangle 51 is provided with multiple interpolation points 52 that can be correspondingly modified by the user in order to achieve an adjustment of rectangle 51 to the outer edge of semiconductor substrate 6. Similarly, the grid lines of first group 54 and the grid lines of second group 55 can be shifted so that they are parallel to the features of the wafer or of semiconductor substrate 6. The transformation of the distorted image of semiconductor substrate 6 into a non-distorted image of semiconductor substrate 6 is then carried out in computer 30 by means of a transformation function. This transformation function can be taken from the Intel Image Processing Library. Once the transformation is complete, the wafer or semiconductor substrate is presented on display 41 as if it had been acquired with a digital camera 11 in perpendicular and non-rotated fashion. This transformation makes possible a very accurate (<0.5 mm) correlation between the pixel coordinates of the CCD chip and the stage coordinates of a stage 60 (see FIG. 3) on which semiconductor substrate 6 is placed. Stage 60 is embodied displaceably in two spatial directions that are perpendicular to one another, for example X and Y.

1. An apparatus for acquiring a complete image of a surface of a semiconductor substrate, comprising: a digital camera having an objective and a CCD chip, wherein the objective defines an optical axis that is perpendicular to the CCD chip, a diffuser screen, and an illumination device that is arranged above the surface of the semiconductor substrate, wherein the optical axis encloses an angle of less than 90° with the surface of the semiconductor substrate, and wherein the angle between the optical axis and the surface of the semiconductor substrate is always dimensioned in such a way that the reflection of the optical axis from the surface of the semiconductor substrate always strikes a diffuser screen.

2. The apparatus as defined in claim 1, wherein the angle equals between 45° and 60°.

3. The apparatus as defined in claim 2, wherein the angle equals 52°.

4. The apparatus as defined in claim 1, wherein the diffuser screen which partially surrounds the semiconductor substrate is arranged behind the semiconductor substrate and opposite the illumination device.

5. The apparatus as defined in claim 1, wherein a first rail is provided on which the digital camera and the illumination device are displaceably mounted; and a second rail is provided on which the diffuser screen is displaceably mounted.

6. The apparatus as defined in claim 5, wherein the digital camera is provided above the illumination device on the first rail.

7. The apparatus as defined in claim 1, wherein the illumination device is provided with multiple displaceable panels that define an emission cone of the illumination device, which cone is configured in such a way that no direct light from the illumination device is incident onto the surface of the semiconductor substrate.

8. The apparatus as defined in claim 1, wherein on the second rail, the diffuser screen is embodied in the shape of a half-cylinder that surrounds approximately half of the semiconductor substrate.

9. The apparatus as defined in claim 1, wherein the semiconductor substrate is a wafer.

10. The apparatus as defined in claim 1, wherein the apparatus is incorporated into a measurement system for the semiconductor industry.

11. The apparatus as defined in claim 1, wherein the apparatus is incorporated into a wafer inspection machine in order to document observed defects.

12. The apparatus as defined in claim 1, wherein the apparatus is integrated into a device for layer thickness measurement.

13. The apparatus as defined in claim 1, wherein the apparatus is a standalone variant that, in a semiconductor fabrication system, distributes the wafer coordinates of measurement sites that are to be examined more closely, as an ASCII file, to other measuring systems.

14. A method for acquiring a complete image of a surface of a semiconductor substrate using a digital camera having an objective and a CCD chip, an objective defining an optical axis that is perpendicular to the CCD chip; and using an illumination apparatus that is arranged above the surface of the semiconductor substrate, comprising the steps of:
aligning the optical axis in such a way that an angle of less than 90° is enclosed with the surface of the semiconductor substrate; and
adjusting the illumination device using multiple displaceable panels in such a way that by means of the illumination device, an emission cone is defined so that no direct light from the illumination device is incident onto the surface of the semiconductor substrate.

15. The method as defined in claim 14, wherein the image acquired with the digital camera is electronically corrected in such a way that the image of the surface of the semiconductor substrate is distortion-free.

16. The method as defined in claim 15, wherein the complete image of the surface of the semiconductor substrate is presented on a display; and the user can select the desired measurement position with a cursor of an input unit, and the semiconductor substrate is placed on a displaceable stage; with which the position selected by the user in the overview image is traveled to.

17. The method as defined in claim 16, wherein a first rail is provided on which the digital camera and the illumination device are displaced; and a second rail is provided on which a diffuser screen is displaced.

18. The method as defined in claim 14, wherein multiple displaceable panels are provided on the illumination device, a lower panel being displaced substantially parallel to the surface of the semiconductor substrate, and a first and a second side panel each being displaced perpendicular to the lower panel; the first and the second panel each have an angled region; and the angled regions point toward one another.

19. The method as defined in claim 14, wherein the semiconductor substrate is a wafer.

20. The method as defined in claim 14, wherein the method is integrated into a standalone apparatus; and in a semiconductor fabrication system, wafer coordinates that are to be examined more closely are distributed as an ASCII file to other measuring systems.
